(19) United States
(12) Patent Application Publication
(10) Pub. No.: US 2021/0041300 A1
(43) Pub. Date: Feb. 11, 2021

(54) SYSTEM FOR DETECTING TEMPERATURE DURING ROASTING AND TRANSMISSION TERMINAL

(71) Applicant: Shenzhen HyperSynes Co., Ltd., Shenzhen (CN)

(72) Inventor: Linqing LIU, Shenzhen (CN)

(73) Assignee: Shenzhen HyperSynes Co., Ltd., Shenzhen (CN)

(21) Appl. No.: 16/912,663

(22) Filed: Jun. 25, 2020

(30) Foreign Application Priority Data
Aug. 7, 2019 (CN) 201910727554.4

(51) Int. Cl. G01K 1/02; A47J 37/07

(52) U.S. Cl. CPC G01K 1/024; A47J 2202/00; A47J 37/0786

(57) ABSTRACT

A system for detecting temperature during roasting includes a roasting probe and a transmission terminal. The roasting probe includes a temperature sensor and a first wireless transmission component. The temperature sensor is used to detect temperature of the roasting probe. The first wireless transmission component sends the detected temperature to the transmission terminal. The transmission terminal includes a shell, a circuit board arranged in the shell, and a second wireless transmission component and a third wireless transmission component connected to the circuit board. When the transmission terminal is connected to a roasting apparatus, the second wireless transmission component enters the roasting apparatus and is used to receive the temperature sent by the first wireless transmission component located on the roasting probe in the roasting apparatus. The third wireless transmission component is located outside the roasting apparatus and sends the temperature to an external terminal.

### CROSS-REFERENCE TO RELATED APPLICATIONS

This application claims priority to Chinese Patent Application No. 201910727554.4 with a filing date of Aug. 7, 2019. The content of the aforementioned application, including any intervening amendments thereto, is incorporated herein by reference.

### TECHNICAL FIELD

The disclosure relates to the field of temperature detection, and particularly relates to a system for detecting temperature during roasting and a transmission terminal.

### BACKGROUND OF THE PRESENT INVENTION

Along with the continuous optimization of the performance and cost of temperature sensors, the application scenarios of the temperature sensors are wider. The traditional heat-sensitive sensor achieves a purpose of temperature measurement according to the change of the resistance value along with the temperature, for example, by using a resistance-type temperature sensor. The sensor needs to be powered. A metal wire for electrification connects the sensor and a temperature measurement apparatus, and due to an excessive length of the metal wire, users cannot move left and right. Furthermore, if the open fire of a barbecue grill burns the electrified metal wire and the sensor, a short circuit may be caused, and the resistance value of the temperature sensor may be damaged, thereby directly affecting the measurement accuracy, For some barbecue grills, it needs to frequently rotate and move food, so the electrified metal wire may be intertwined and cannot be used at all.

In the prior art, the temperature sensor must use the metal wire for power supply and data transmission. The metal wire is prone to be intertwined and burned, and to affect the actions of people, which brings about great inconvenience to the temperature detection.

### SUMMARY OF PRESENT INVENTION

In view of this, embodiments of the disclosure provide a system for detecting temperature during roasting and a transmission terminal.

Embodiments of the disclosure provide a system for detecting temperature during roasting, which includes at least one roasting probe and a transmission terminal.

The at least one roasting probe includes a temperature sensor for detecting temperature of the roasting probe and a first wireless transmission component for transmitting the temperature detected to the transmission terminal.

The transmission terminal includes a shell, a circuit board arranged in the, shell, and a second wireless transmission component and a third wireless transmission component connected to the circuit board. When the transmission terminal is connected to a roasting apparatus, the second wireless transmission component enters the roasting apparatus, and the second wireless transmission component is used to receive the temperature sent by the first wireless transmission component located on the roasting probe in the roasting apparatus and send the temperature to the third wireless transmission component through the circuit board. When the transmission terminal is connected to the roasting apparatus, the third wireless transmission component is located outside the roasting apparatus and sends the temperature to an external terminal.

Embodiments of the disclosure further provide a transmission terminal, which includes: a shell; a connecting part defined on the shell and used to connect the transmission terminal to an external roasting apparatus; a second wireless transmission component, wherein when the transmission terminal is connected to the external roasting apparatus, the second wireless transmission component is located in the roasting apparatus and used to receive the temperature sent by the roasting probe located in the roasting apparatus; and a third wireless transmission component, wherein when the transmission terminal is connected to the external roasting apparatus, the third wireless transmission component is located outside the roasting apparatus and used to send the temperature received by the second wireless transmission component to the external terminal.

The transmission terminal of the system for detecting temperature during roasting provided in embodiments of the disclosure includes two wireless transmission components, and in a use process, one wireless transmission component is arranged in the roasting apparatus, and the other wireless transmission component is arranged outside the roasting apparatus.

### DESCRIPTION OF THE DRAWINGS

In order to make the technical solutions in the embodiments of the disclosure described more clearly, the drawings associated to the description of the embodiments will be illustrated concisely hereinafter. Obviously, the drawings described below are only some embodiments of the disclosure. Numerous drawings therein will be apparent to one of ordinary skill in the art based on these drawings descried in the disclosure without creative efforts.

FIG. 1 is a schematic diagram showing a use state of a system for detecting temperature during roasting according to embodiments of the disclosure;

FIG. 2 is a structural block diagram of a system for detecting temperature during roasting according to embodiments of the disclosure;

FIG. 3 is a structural block diagram, of a roasting probe according to embodiments of the disclosure;

FIG. 4 is a structural schematic diagram of a transmission terminal according to embodiments of the disclosure;

FIG. 5 is a structural schematic diagram of a second wireless transmission component according to embodiments of the disclosure;

FIG. 6 is a sectional view of a connecting part according to embodiments of the disclosure;

FIG. 7 is a schematic diagram of an equivalent circuit of an antenna according to embodiments of the disclosure;

FIG. 8 is another structural schematic diagram of the second wireless transmission component according to embodiments of the disclosure;

FIG. 9 is another sectional view of the connecting part according to embodiments of the disclosure; and

FIG. 10 is another schematic diagram of the equivalent circuit of the antenna according to embodiments of the disclosure.

### DETAILED DESCRIPTION OF PREFERRED EMBODIMENTS

In the following description, for the purpose of illustration rather than limitation, specific details such as specific system structures and technologies are proposed in order to thoroughly understand the embodiments of the disclosure. However, it should be understand that the disclosure can be realized in other embodiments without these specific details by one of ordinary skill in the art. In other cases, detailed description of well-known systems, apparatuses, circuits and methods are omitted so as to prevent unnecessary details from obstructing the description of the disclosure.

Terms “first”, “second” and the like in the embodiments of the disclosure are only used to distinguish related technical features, and do not indicate a sequence.

In order to explain the technical solution of the disclosure, specific embodiments will be described below.

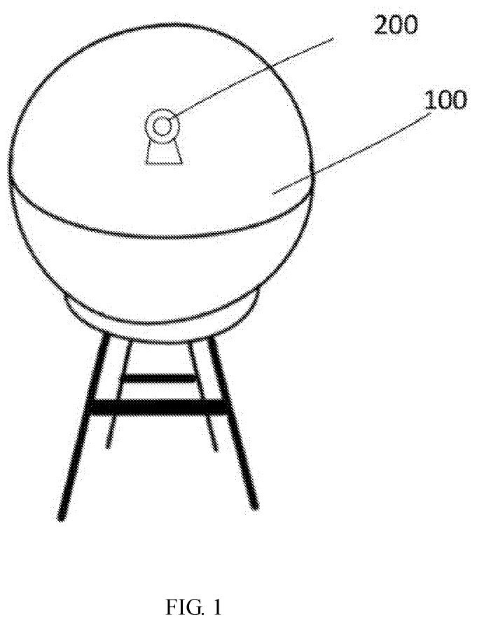

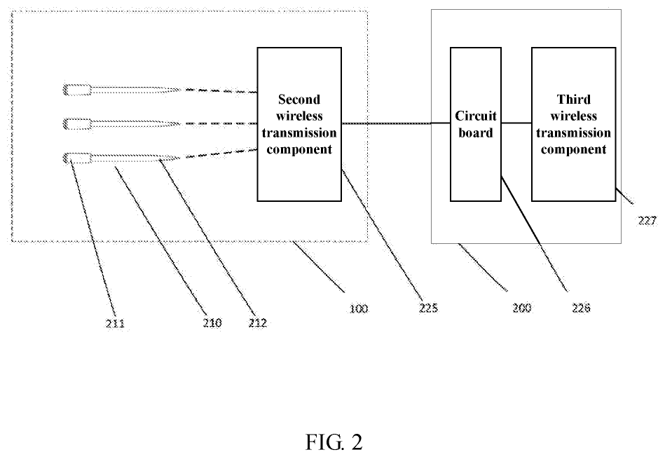

FIGS. 1-2 show a use state of a system 200 for detecting temperature during roasting according to embodiments of the disclosure. The system 200 includes at least one roasting probe 210 and a transmission terminal 220.

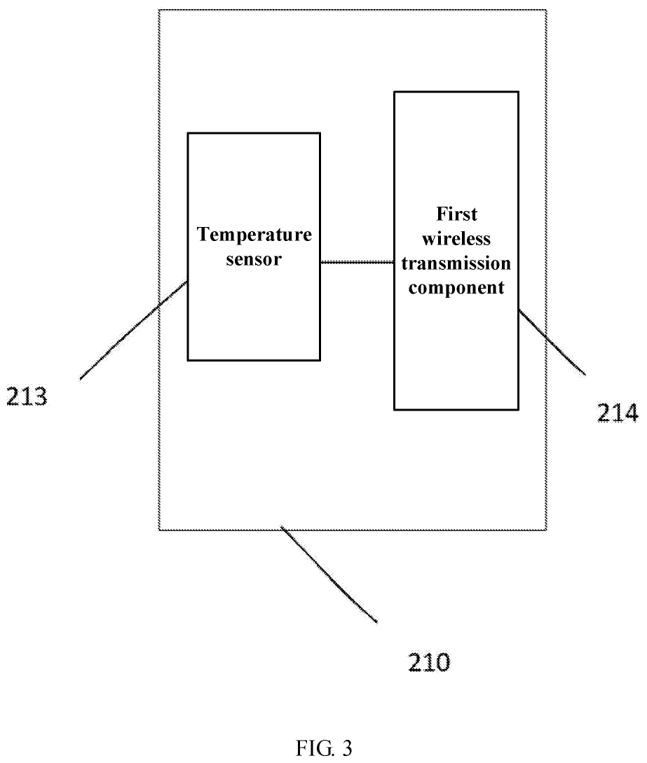

As shown in FIG. 3, the roasting probe 210 includes a temperature sensor 213, and the temperature sensor may further be used as a temperature measurement sensor.

As shown in FIG. 3, the roasting probe 210 further includes a first wireless transmission component 214, and the first wireless transmission component is used to send or feed back a wireless signal reflecting temperature. Specifically, the first wireless transmission component 214 may be an antenna capable of transmitting or feeding back the wireless signal, such as a surface acoustic wave antenna or an RFID (Radio Frequency Identification) antenna.

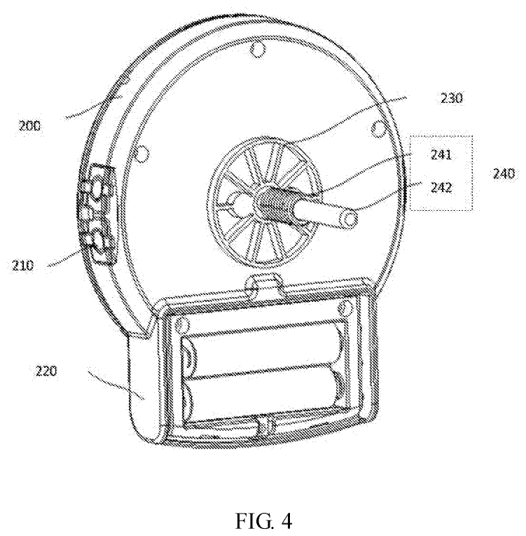

FIG. 4 shows a schematic structure of the transmission terminal 220 according to the embodiments of the disclosure. The transmission terminal 220 described in the embodiments of the disclosure is an apparatus for collecting barbecue temperature and sending the temperature to an external terminal, such as a mobile phone.

Specifically, the transmission terminal 220 includes a shell 222, and other parts on the transmission terminal 220 are directly or indirectly fixed on the shell 222 of the transmission terminal 220. The transmission terminal 220 further includes a circuit board 226. The circuit board 226 is used to establish electric connection of the transmission terminal 220 and to process the wireless signal received or to be sent by the transmission terminal 220. According to an exemplary implementation, the circuit board 226 of the transmission terminal includes parts such as a processor, a power supply, a plated circuit (or a printed circuit) and the like. The circuit board 226 may process the received wireless signal reflecting the temperature and convert the signal into a wireless signal which can be sent to the mobile phone.

In the present embodiment, the transmission terminal 220 further includes a second wireless transmission component 225 and a third wireless transmission component 227. The second wireless transmission component 225 and the third wireless transmission component 227 are both connected to the circuit board 226.

In a use process of the system for detecting temperature during roasting according to the embodiments of the disclosure, the transmission terminal 220 is connected to a roasting apparatus 100. The roasting apparatus 100 according to the embodiments of the disclosure includes but is not limited to the apparatus capable of heating food such as a barbecue grill, a baking oven, a microwave oven and the like.

A specific application scenario is that the roasting apparatus 100 is provided with one or more holes. Some conventional sensors such as the temperature sensor may be installed in the one or more holes, and are used to detect the temperature in the roasting apparatus 100. Taking the barbecue grill serving as the roasting apparatus 100 as an example, FIG. 1 is a structural schematic diagram of the barbecue grill according to the embodiment of the disclosure. One or more holes are defined in a grill cover of the barbecue grill. The barbecue grill includes a support (not shown in the drawing) used to support a shell of the barbecue grill. An area of the roasting apparatus 100 used for heating the foot is located in the roasting apparatus. In order to make full use of the heat energy, the roasting apparatus 100 may be set as a sealed environment or a generally-sealed environment, i.e. one or more pores may be arranged on the roasting apparatus 100. The second wireless transmission component 225 goes deep into the roasting apparatus and receives the temperature transmitted or fed back by the roasting probe 210 which is also located in the roasting apparatus 100. The third wireless transmission component 227 is arranged outside the roasting apparatus and acquires the temperature detected by the roasting probe 210 through the circuit board 226. The second wireless transmission component 227 sends the acquired temperature to an external terminal. Through the solution provided by the embodiment of the disclosure, in the roasting apparatus, the first wireless transmission component 214 is wirelessly connected with the second wireless transmission component 225, and outside the roasting apparatus, the third wireless transmission component is connected with the external terminal, so that the problem that the roasting apparatus shields the wireless signal can be solved.

The external terminal includes but is not limited to an electronic apparatus capable of checking the temperature such as a computer, a server, a tablet computer, a smart phone, a handhold device, a consumption electronic device, and the like. Preferably, the third wireless transmission component is a WIFI module, a Bluetooth module, and the like.

According to an exemplary implementation, the roasting probe 210 includes a probe cap 211 and a probe head 212. The probe cap 211 is connected to one end, which is away from the food insertion, of the probe head 212. Specifically, the probe head 212 is composed of a metal shell with a small end, and the temperature sensor 213 is arranged in the probe head 212. The temperature sensor is sealed in the probe head 212. The first wireless transmission component 214 is at least partially arranged in the probe cap 211 and is connected with the temperature sensor 213.

The roasting probe 210 may include one or more temperature sensors 213. The temperature sensor 213 is arranged in the probe head 212. More preferably, at least one temperature sensor 213 is arranged on a position which is close to the small end of the probe head 212, so that the temperature inside the food can be detected as far as possible. A plurality of temperature sensors 213 may be uniformly or non-uniformly distributed in the probe head 212.

According to a specific implementation, the first wireless transmission component 214 is a surface acoustic wave transmission antenna, and the temperature sensor 2.13 is a surface acoustic wave chip. The second wireless transmission component 225 in the transmission terminal 220 according to the embodiment of the disclosure is a surface acoustic wave transceiver antenna. The surface acoustic wave transceiver antenna on the transmission terminal 220 sends a first wireless signal to the surface acoustic wave reflector antenna on the roasting probe 210. The surface acoustic wave temperature sensing chip is used to convert the first wireless signal to a second wireless signal carrying the temperature information of the roasted food. The surface acoustic wave transmission antenna in the roasting probe 210 is used to receive the first wireless signal and feed back the second wireless signal to the surface acoustic wave transceiver antenna of the transmission terminal 220.

In the present embodiment, the system includes at least two roasting probes 210. The surface acoustic wave temperature sensing chips of roasting probes 210 work in different frequency ranges. The first wireless signal and the second wireless signal are electromagnetic wave signals. If a user needs to detect the temperature of different portions of a large piece of grilled meat, the plurality of roasting probes 210 are inserted into the different portions of the grilled meat. For example, three roasting probes 210 are used here; the surface acoustic wave sensing chips in the three roasting probes 210 work in three, different frequency ranges respectively; for example, the working frequency range of the chip of the first roasting probe is 91 MHz-95 MHz, the working frequency range of the chip of the second roasting probe is 96 MHz-100 MHz, and the working frequency range of the chip of the third roasting probe is 101 MHz-105 MHz. The present embodiment adopts the low-frequency range, but is not limited to the low frequency. It should be understood that the purpose of the disclosure can also be achieved in the medium frequency and the high frequency.

According to another feasible implementation of the disclosure, the first wireless transmission component 214 is an antenna. The first wireless transmission component 214 is used to receive the electromagnetic signal sent by the second wireless transmission component 225 and convert the electromagnetic signal to electric energy so, as to power the temperature sensor 213. One part of the electric energy is used for the temperature sensor 213 to detect the temperature, and the other part of the electric energy is used to feed back the temperature to the second wireless transmission component 225. Specifically, the roasting probe 210 can feed back the temperature to the second wireless transmission component 225 directly through the first wireless transmission component 214, and a new antenna module (not shown in the drawing) may further be separately arranged to feed back the temperature to the second wireless transmission component 225.

According to another implementation of the disclosure, the roasting probe 210 includes a probe power supply (not shown in the drawing), a probe circuit (not shown in the drawing), the first wireless transmission component 214 and the temperature sensor 213.The probe power supply supplies power to the probe circuit. The probe circuit processes the temperature detected by the temperature sensor 213 and sends the temperature to the second wireless transmission component 225 of the transmission terminal through the first wireless transmission component 214. Specifically, the first wireless transmission component may be an antenna capable of transmitting the wireless signal, such as a 2.4G antenna, a Bluetooth antenna or a WiFi antenna. The 2.4G is a wireless technology, and the frequency range thereof is between 2.400 GHz-2.4835 GHz.

FIG. 4 shows a schematic structure of the transmission terminal 220 according to the embodiment of the disclosure. Specifically, the transmission terminal includes a connecting part 224. The connecting part 224 is arranged on the back of the shell 222 and extends to form an elongated structure.

According to an exemplary implementation, the connecting part includes a connecting rod 2242.The connecting rod 2242 may further be provided with a connecting rod fixed portion 2241, such as connecting threads. FIG. 4 shows a specific structure of the connecting part according to the embodiment of the disclosure. The connecting part 224 includes a connecting rod 2242 and connecting threads 2241. The transmission terminal 220 is connected with the roasting apparatus 100 through the connecting part.

According to a specific implementation, the above connecting rod 2242 includes a hollow conductive connecting rod 2242. The hollow conductive connecting rod 2242 includes a conducting circuit 2243. An insulation layer is filled between the conducting circuit and the conductive connecting rod 2242 to insulate the conductive connecting rod 2242 and the conducting circuit 2243. An axis of the conducting circuit 2243 is arranged on the central axis of the conductive connecting rod 2242.

According to a specific implementation, the second wireless transmission component 225 in the transmission terminal 220 is arranged on the connecting part 224 and enters the roasting apparatus 100 along with the connecting part. Specifically, the second wireless transmission component 225 may be connected to the end of the connecting part 224.

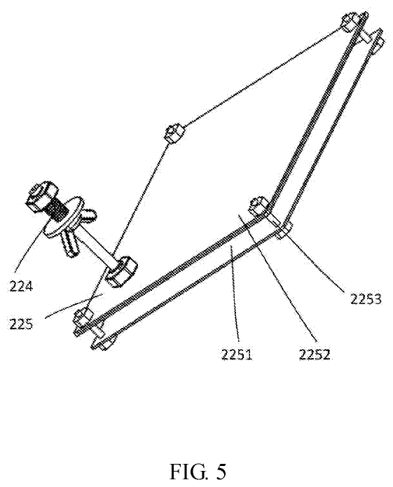

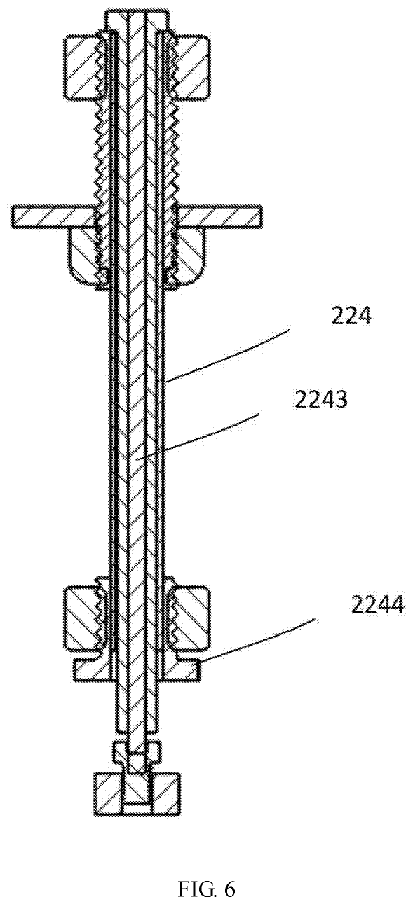

According to a specific implementation, the second wireless transmission component 225 in the transmission terminal 220 may be detachably connected to the connecting part 224. Specifically, as shown in FIGS. 5-6, the second wireless transmission component 225 is a flat antenna. Specifically, the flat antenna may include two parallel flat antenna components, i.e. a first flat antenna 2251 and a first flat antenna 2251, and the two first flat antennas 2251 are connected through an antenna connecting piece 2253. In order to ensure that the two first flat antennas 2251 are in parallel, the present embodiment adopts four antenna connecting pieces 2253 which are arranged on the periphery of the flat antenna components respectively.

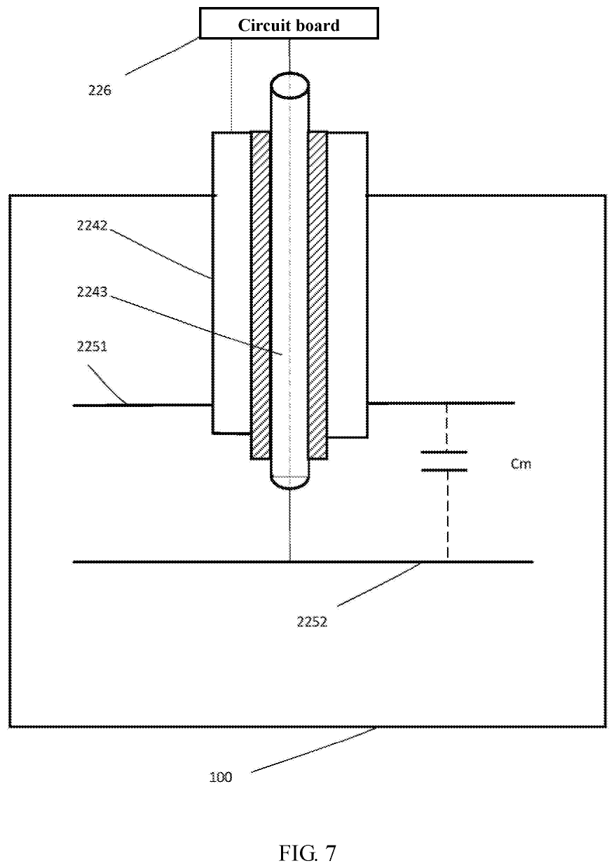

FIG. 7 is an equivalent circuit diagram of the flat antenna shown in FIGS. 5-6. The connecting part 224 includes the hollow conductive connecting rod 2242 and the conducting circuit 2243 arranged inside the connecting rod 2242. The insulation layer is arranged between the conducting circuit 2243 and the connecting rod 2242. The connecting rod 2242 is electrically connected with an outer wall of the external roasting apparatus 100, and the connecting rod 2242 is electrically connected with one of the first flat antennas 2251. The conducting circuit 2243 is electrically connected with a second flat antenna 2252. The first flat antenna is distanced to and is parallel to the second flat antenna, thereby forming a set capacitance (Cm). Thus, the outer wall of the roasting apparatus 100 can be used as a reference antenna. The first flat antenna 2251 connected with the outer wall of the roasting apparatus 100 is further used as the reference antenna to form oscillation with the second flat antenna 2252 so as to send the wireless signal.

According to a specific implementation, the connecting part 224 further includes the conducting circuit 2243 arranged inside the connecting part 224, and the conducting circuit 2243 is electrically connected with the second wireless transmission component 225. The conducting circuit is used to transmit the signal received by the second wireless transmission component 225 and to provide energy to the second wireless transmission component 225. The connecting part 224 further includes a connecting part fixing piece 2244. The second wireless transmission component is connected to the connecting part 224 through the connecting part fixing piece 2244.

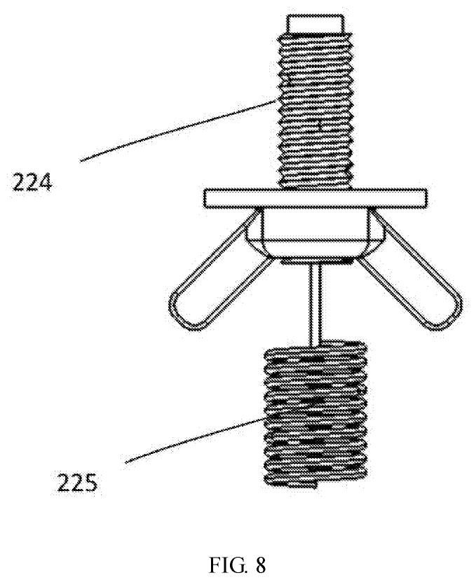

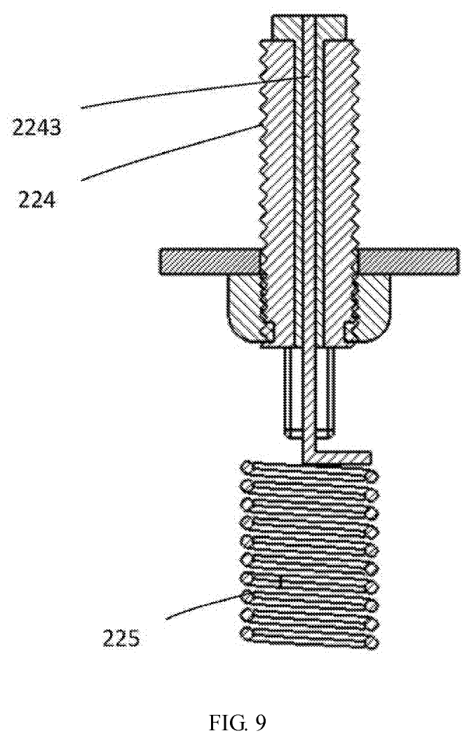

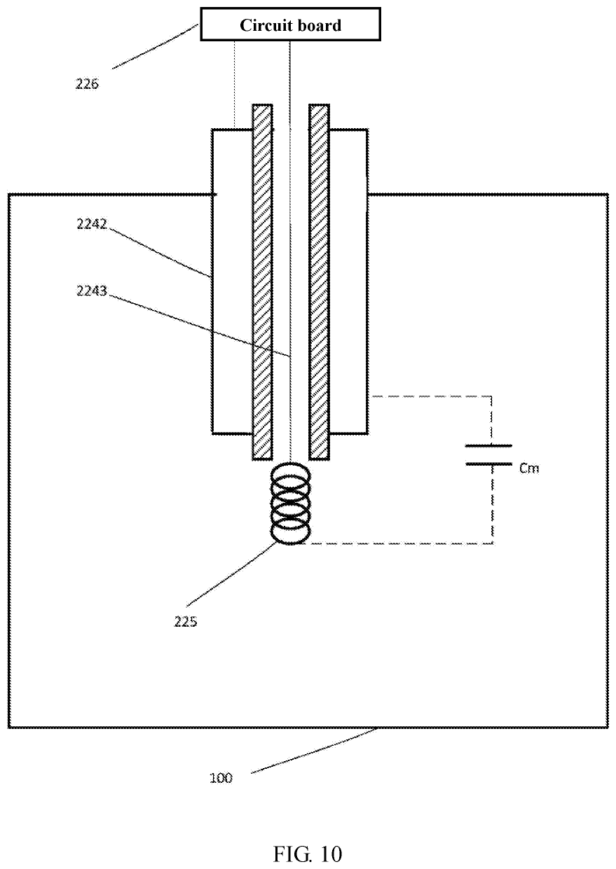

According to another feasible implementation of the disclosure, as shown in FIGS. 8-10, the second wireless transmission component 225 is a spiral antenna. The second wireless transmission component 225 of the spiral antenna is detachably connected to the connecting part 224 and is electrically connected with the conducting circuit in the connecting part 224. The spiral antenna 225 includes a spiral portion and an axis conductor. The axis conductor is on the central axis of the spiral portion. The connecting part 224 includes the hollow conductive connecting rod 2242. According to a feasible implementation, the central axis of the spiral antenna 225 passes through the connecting rod 2242 and is located on the axis of the connecting rod. According to another feasible implementation, the connecting rod 2242 further includes the conducting circuit 2243, and the conducting circuit is electrically connected with the axis conductor of the spiral antenna. The connecting rod 2242 is electrically connected with the outer wall of the roasting apparatus 100. Thus, the outer wall of the roasting apparatus 100 can be used as the reference antenna. The spiral antenna 225 forms an equivalent capacitance with the outer wall of the roasting apparatus and finally sends the wireless signal along with the oscillation of an electric signal.

According to another specific implementation of the disclosure, the transmission terminal further includes a pairing component, and specifically the pairing component may be a pairing button. Under a set condition, for example, when a user presses the pairing button and starts a network connecting request on the external terminal within a set time, the network connection with the external terminal is established.

Embodiments of the disclosure further provide the transmission terminal 220 including: a shell 222; a connecting part 224 arranged on the shell 222 and used to connect the transmission terminal 220 to the external roasting apparatus 100; a second wireless transmission component 225, wherein when the transmission terminal 220 is connected to the external roasting apparatus 100, the second wireless transmission component 225 is located in the roasting apparatus 100 and used to receive the temperature sent by a roasting probe 210 located in the roasting apparatus 100; and a third wireless transmission component 227, wherein when the transmission terminal 220 is connected to the external roasting apparatus 100, the third wireless transmission component 227 is located outside the roasting apparatus and used to send the temperature received by the second wireless transmission component 225 to an external terminal.

It should be recognized by one of ordinary skill in the art that units and algorithm steps of various examples described in the embodiments disclosed herein can be realized by electronic hardware or a combination of computer software and the electronic hardware. Whether these functions are executed with hardware or software depends on the specific application and designed constraint conditions of the technical solution. Professional technicians can use different methods to realize the described functions for each specific application, and such realization should also follow into the scope of the disclosure.

The above embodiments are only used for illustrating the technical solutions of the disclosure rather than limiting the disclosure. Although the disclosure is described in detail with reference to the foregoing embodiments, it should be understood by those of ordinary skill in the art that the technical solutions described in the foregoing embodiments may be modified or some technical features may be equivalently substituted. However, these modifications or substitutions do not depart from the spirit and scope of the technical solutions of various embodiments of the disclosure, and should be included in the protection scope of the disclosure.

We claim:

1. A system for detecting temperature during roasting, comprising at least one roast probe and a transmission terminal, wherein
the at least one roasting probe comprises a temperature sensor for detecting temperature of the roasting probe and a first wireless transmission component for transmitting the temperature detected to the transmission terminal;
the transmission terminal comprises a shell, a circuit board arranged in the shell, and a second wireless transmission component and a third wireless transmission component connected to the circuit board; when the transmission terminal is connected to a roasting apparatus, the second wireless transmission component enters the roasting apparatus, and the second wireless transmission component is used to receive the temperature sent by the first wireless transmission component located on the roasting probe in the roasting apparatus and send the temperature to the third wireless transmission component through the circuit board; and when the transmission terminal is connected to the roasting apparatus, the third wireless transmission component is located outside the roasting apparatus and sends the temperature to an external terminal.

2. The system according to claim 1, wherein the transmission terminal further comprises a connecting part, and the transmission terminal is connected with the roasting apparatus through the connecting part.

3. The system according to claim 2, wherein the second wireless transmission component is arranged on the connecting part, and the second wireless transmission component is located in the roasting apparatus.

4. The system according to claim 3, wherein the second wireless transmission component is arranged on an end of the connecting part.

5. The system according to claim 2, wherein the second wireless transmission component is detachably connected to the connecting part.

6. The system according to claim 2, wherein the connecting part comprises a connecting rod and a conducting circuit arranged inside the connecting rod; the transmission terminal is connected with the roasting apparatus through the connecting rod; and the second wireless transmission component is connected with the transmission terminal through the conducting circuit.

7. The system according to claim 1, wherein the first wireless transmission component is a surface acoustic wave reflector antenna;
the second wireless transmission component is a surface acoustic wave transceiver antenna; and
the second wireless transmission component sends a first wireless signal to the first wireless transmission component, and receives a second wireless signal fed back by the first wireless transmission component.

8. The system according to claim 1, wherein the roasting probe comprises a probe power supply; and the probe power supply supplies power for the first wireless transmission component to send the temperature to the second wireless transmission component.

9. The system according to claim 1, wherein the first wireless transmission component in the roasting probe is used to convert a wireless signal sent by the second wireless transmission component into electric energy so as to provide energy required by the temperature sensor for measuring the temperature; and the first wireless transmission component receives an electrical signal reflecting the temperature fed back by the temperature sensor, and sends the temperature to the second wireless transmission component.

10. A transmission terminal, comprising:
a shell;
a connecting part defined on the shell and used to connect the transmission terminal to an external roasting apparatus;
a second wireless transmission component, wherein when the transmission terminal is connected to the external roasting apparatus, the second wireless transmission component is located in the roasting apparatus and used to receive temperature sent by the roasting probe located in the roasting apparatus; and
a third wireless transmission component, wherein when the transmission terminal is connected to the external roasting apparatus, the third wireless transmission component is located outside the roasting apparatus and used to send the temperature received by the second wireless transmission component to an external terminal.
